(19) United States
(12) Patent Application Publication
(10) Pub. No.: US 2010/0017886 A1
(43) Pub. Date: Jan. 21, 2010

(54) SYSTEM AND METHOD FOR REMOTELY TRACKING AN ACTIVATION OF PROTECTED SOFTWARE

(75) Inventors: Eric Desmicht, Caen (FR); Stephane Mutz, Cuverville (FR); Menno Kleingeld, Malden (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/520,242

(22) PCT Filed: Dec. 11, 2007
(86) PCT No.: PCT/IB07/55012

§ 371 Date: Jun. 19, 2009

(30) Foreign Application Priority Data
Dec. 22, 2006 (EP) 06292043.4
Dec. 11, 2007 (IB) PCT/IB2007/055012

(51) Int. Cl. G06F 21/22

(52) U.S. Cl. 726/26; 713/155

(57) ABSTRACT

The invention is related to a system (2) for remotely tracking the activation of a protected software in a device (4), the system (2) comprises a plurality of devices (4) and an authorisation apparatus (6). Each device (4) comprises an electronic chip (8) having an identification number uniquely identifying the electronic chip (8). The authorisation apparatus (6) comprises an encryption processor (18) adapted to calculate an encrypted identity. Each device (4) is adapted to transmit its identification number to the authorisation apparatus (6), the authorisation apparatus (6) is adapted to record the received identification number and to transmit an encrypted identity. The device (4) contains a decryption processor (12) adapted to decrypt the transmitted encrypted identity to produce a decrypted identity and the electronic chip (8) activates the protected software only if the identification number of the device (4) corresponds to the decrypted identity.

### FIELD OF THE INVENTION

The present invention relates to remote tracking of the activation of protected software for use by an electronic device.

### BACKGROUND OF THE INVENTION

Many mature customer electronic device technologies such as DVD players and cathode ray tube televisions are manufactured by original design manufacturers (ODM) as a result of partnerships formed between ODMs and the proprietors of these technologies who are generally large multinational electronics companies. An ODM is a company which manufactures a product that will ultimately be branded by another firm when put on sale. Such ODM companies allow the brand firm to produce without it having to engage in the organisation of device manufacturing. Although ODMs have attractive manufacturing capabilities, they lack resources for research and development (R&D) of these devices.

To overcome the lack of research and development, the ODMs are supplied with hardware and software solutions that allow these electronic devices to be developed and to respond to customer needs. The hardware and software solutions are “turnkey solutions” meaning that they are fully developed solutions that only need to be copied and placed in the electronic device.

These “turnkey solutions” software solutions are very often produced with the assistance of independent software vendors (ISV) who supply software solutions for the electronic devices. The independent software vendors receive royalty payments for the intellectual property rights associated with the software and in general a royalty payment is due for each electronic device sold that uses their software solution. The royalty payment amount can depend on the country in which the device was sold and the version of the software that is used by the electronic device.

However, it is often difficult to determine the total number of devices sold, the number sold in a particular country, the software version that is being used in a device and it is also difficult to verify any quoted sales number as sales can be worldwide. As a result the ISVs are in a vulnerable position and may loose royalty payments that are due to them.

It is thus desirable to have a system and a method for remotely tracking the activation of protected software in electronic devices.

U.S. Pat. No. 5,875,248 describes a data processing system comprising a processor card containing a system processor, a plurality of memory cards connected to the processor card via a memory bus and input/output cards connected to the processor card via an input/output bus.

Each card contains a smart chip and the smart chips are interconnected via a serial bus. The smart chip comprises a smart chip processor, a read only memory (ROM) and a non-volatile memory.

The non-volatile memory contains a unique serial number and a first encryption key. The first encryption key is generated using the unique serial number, a second key and an encryption algorithm during manufacturing of the smart chip and the first encryption key is subsequently stored in the non-volatile memory.

The system processor has knowledge of the encryption algorithm and the second key. It is adapted to read the unique serial number in the smart chip of any card and to calculate the first encryption key using the encryption algorithm and the second key. The system processor is also adapted to verify that the generated first encryption key matches the first encryption key stored in the non-volatile memory.

### OBJECT AND SUMMARY OF THE INVENTION

It is an object of the present invention to provide a system for remotely tracking the activation of protected software in at least one device.

Additionally, the invention concerns a method for remotely tracking the activation of protected software in at least one device according to claim 6.

Other features of the system and the method are found in the dependent claims.

### BRIEF DESCRIPTION OF THE DRAWINGS

The above object, features and other advantages of the present invention will be best understood from the following detailed description in conjunction with the accompanying drawings, in which:

FIG. 1 is a schematic block diagram of a system for remotely tracking the activation of protected software in a plurality of devices according to the invention;

FIG. 2 is a flow chart of a method for remotely tracking the activation of protected software in at least one device according to the invention.

In the drawings, the same reference numbers are used to designate the same elements.

### DETAILED DESCRIPTION OF EMBODIMENTS

The system and method for remotely tracking the activation of protected software in at least one device according to the invention is suited for use with devices containing protected software where the proprietor or the intellectual property rights holder of the protected software needs to safeguard against unauthorised copying of the protected software and to verify that devices sold on the market using the protected software have corresponding licences that have been paid for the use of the protected software.

The protected software can be for example software stored in a device or software implemented in a hardware configuration to represent the software.

The system and method can be employed, for example, with devices containing software necessary for managing the operation of a device or that is necessary to implement certain additional functions such as for example the disablement in DVD players of region checking for countries where regional lockout or regional coding enhancement (RCE) has been declared illegal by competition authorities.

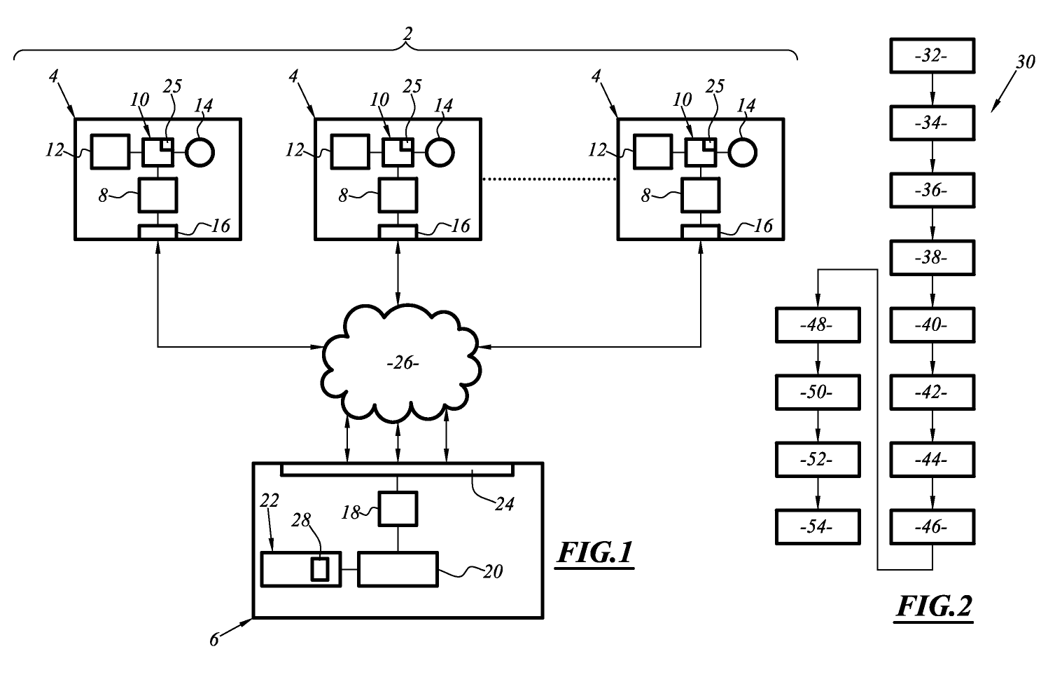

FIG. 1 illustrates a schematic block diagram of a system 2 for remotely tracking the activation of protected software in a plurality of devices 4 according to the invention.

The system 2 comprises a plurality of devices 4 and an authorisation apparatus 6. The device 4 in the current embodiment is for example a set top box (STB) and the authorisation apparatus 6 is for example a centralised server that keeps track and records all communicated data between it and any STB.

Each device 4 contains an electronic chip 8 containing an identification number that uniquely discriminates this device 4 from any other device 4 of the system 2, a device memory 10, a decryption processor 12, a storage unit 14 containing protected software and a device communication interface 16 adapted to communicate with the authorisation apparatus 6.

The authorisation apparatus 6 contains an encryption processor 18, a central processor 20, a storage unit 22 and an apparatus communication interface 24 adapted to communicate with a device 4.

The protected software in the current embodiment comprises software that controls the operation of the device 4 and for example permits the STB to decode and display a received digital television signal. The protected software is partly scrambled having a certain number of program instructions at the beginning of the protected software that are scrambled.

The electronic chip 8 of the device 4 is an integrated electronic circuit comprising semiconductor electronic devices fabricated on a substrate of semiconductor material. The electronic chip 8 operates as a microprocessor and is adapted to control the device memory 10, the decryption processor 12, the storage unit 14 and the communication interface 16 as well as communication between these device components. The electronic chip 8 is also adapted to communicate with the authorisation apparatus 6 through the communication interface 16 and to descramble the scrambled program instructions of the protected software using a descrambling key.

The electronic chip 8 contains a programmable read-only memory (PROM) that contains the unique identification number. The unique identification number has 56 bits and is permanently written during fabrication of the electronic chip 8. The unique identification is a number incremented by one unit each time a new chip is produced and consequently two chips cannot have the same identifier. The unique identification number is not modifiable or erasable and can be read using adapted software at a predetermined register address. Each electronic chip 8 in each device 4 contains a different unique identification number and no two electronic chips 8 have the same unique identification number.

The device memory 10 is a non-volatile flash memory containing an authorisation program 25 that is executed by the electronic chip 8 upon the first power-up/activation of the device 4, that is when the device 4 is switched on for the first time. The authorisation program 25 contains instructions that organises data communication and manages the processing of data exchanged between the device 4 and the authorisation apparatus 6. The authorisation program 25 executed by the electronic chip 8 attempts to gain authorisation from the authorisation apparatus 6 for the protected software to be activated for use by the device 4.

The device communication interface 16 comprises a universal asynchronous receiver-transmitter (UART) to convert the data to be communicated from the device 4 into a serial format, a RS-232 serial port and a modem for communication with the authorisation apparatus 6 via a communications network 26. The modem prepares and transmits data from the RS-232 serial port to the communications network 26 and receives and transfers data from the communications network 26 to the electronic chip 8 via the RS-232 serial port. In the current embodiment, the modem of a personal computer is connected between the RS-232 serial port and the communications network 26 and the internet is used as the communications network 26 as the devices 4 and the authorisation apparatus 6 are separated by a considerable distance and the devices 4 are distributed worldwide.

The electronic chip 8 is adapted to transmit its unique identification number via the device communication interface 16 to the authorisation apparatus 6. The electronic chip 8 is also adapted to transmit additional data to the authorisation apparatus 6 with the unique identification number. For example, a software identity related to the software version or the software type stored in the device 4 or a geographical identity concerning the geographical location of the device 4. Data concerning the software version or type is stored in the device memory 10. If the device 4 contains a plurality of software versions or different software types, the electronic chip 8 is adapted to transmit its unique identification number and the software identity for each software version and each software type contained in the device 4 to the authorisation apparatus 6.

Data concerning the geographical location of a device may be recovered via the internet service provider or through the internet protocol (IP) address attributed to the personal computer transmitting on the internet. The internet protocol (IP) address may be sent by electronic chip 8 to the authorisation apparatus 6 allowing it to subsequently locate geographically the device 4.

The storage unit 14 is a non-volatile flash memory and contains protected software that is adapted to control the operation of the device 4. In the current embodiment the storage unit 14 of each device 4 contains identical protected software.

In alternative embodiments each device 4 may contain different types of software that is used or implemented in various different ways by a device 4.

The authorisation apparatus 6 is connected to the communications network 26 via the apparatus communication interface 24. The apparatus communication interface 24 comprises a modem that receives data sent from the device communication interface 16 via the communications network 26 and that transmits data to the device communication interface 16 from the authorisation apparatus 6.

The central processor 20 of the authorisation apparatus 6 is adapted to control the encryption processor 18, the storage unit 22 and the apparatus communication interface 24. The central processor 20 is adapted to communicate with any device 4 via the apparatus communication interface 24. The storage unit 22 comprises a hard disk drive 22 that contains an authorisation table 28.

The central processor 20 is adapted to read data in the authorisation table 28 and write data to the authorisation table 28 following a communication with any device 4. The central processor 20 is adapted to record the unique identification number of a device 4 when it is transmitted following the first power-up/activation of the device 4. The time and date at which the unique identification number was received is also recorded. The central processor 20 is adapted to record all data that is transmitted to it from any device 4 such as the software version or type and the geographical location of a device 4. The central processor 20 is also adapted to record all data that is sent to a device 4 from the authorisation apparatus 6.

The decryption processor 12 of the device 4 and the encryption processor 18 of the authorisation apparatus 6 are adapted to implement a cryptography algorithm. In the current embodiment the RSA public-key encryption algorithm is employed. The RSA algorithm involves two keys, a public key and a private key, and a cipher comprising an encryption function and a decryption function.

The storage unit 22 of the authorisation apparatus 6 contains the private key and the encryption function. The encryption processor 18 is adapted to calculate an encryption identity (a ciphertext) using the private key and the encryption function. The encryption processor 18 calculates an encryption identity using the private key and the encryption function that are applied to a plaintext value comprising the unique identification number that has been transmitted to the authorisation apparatus 6 from a device 4. The 56 bit unique identification number is converted to a decimal number using binary coded decimal decoding before being encrypted. Once calculated, the central processor 20 is adapted to transmit the encryption identity to the device 4.

The device memory 10 of the device 4 contains the public key and the decryption function. The decryption processor 12 is adapted to calculate a decryption identity (the plaintext) using the public key and the decryption function. The decryption processor 12 calculates a decryption identity using the public key and the decryption function applied to the encryption identity (the ciphertext) that has been calculated by the encryption processor 18.

For example the RSA public-key encryption algorithm can be implemented using the encryption function

Encrypt(plaintext)=(plaintext)^{e} mod n Equation (1)

and the decryption function

Decrypt(ciphertext)=(ciphertext)^{d} mod n Equation (2)

where
n is the result of the multiplication of two prime numbers and n is known to both the decryption processor 12 and the encryption processor 18;
e is the private key known only to the authorisation apparatus 6;
d is the public key known to all parties;
mod is the modulo operation; and
(X)^{e} is the parameter X raised to the power of e.

For example, if the plaintext value/unique identification number is 123 and n=3233 (from prime numbers 61 and 53), e=17 and d=2753, the resulting ciphertext or encryption identity is calculated as being

Encrypt(123)=(123)¹⁷ mod 3233=855.

This encryption identity is transmitted to the device 4 from the authorisation apparatus 6. The decryption identity is then calculated by the authorisation apparatus 6 by applying the decryption function to the encryption identity

Decrypt(855)=(855)²⁷⁵³ mod 3233=123 and the resulting decryption identity is as expected the plaintext value/unique identification number.

The authorisation apparatus 6 is adapted to transmit the encrypted identity and a descrambling key for descrambling the protected software to the device 4 via the apparatus communication interface 24. A descrambling key is associated with each unique identification number and is contained in the authorisation table 28.

FIG. 2 is a flow chart of a method 30 for remotely tracking the activation of protected data in at least one device 4 according to the invention. The method comprises the steps of:
transmitting 32 the unique identification number of the electronic chip 8 from the device 4 to the authorisation apparatus 6;
recording 34 the unique identification number of the electronic chip 8 in the authorisation table 28;
comparing 36 the unique identification number to the unique identification numbers previously recorded in the authorisation table 28;
transmitting 38 a randomly generated encryption identity to the device 4 if the unique identification number is already present in the authorisation table 28;
calculating 40 an encrypted identity from the transmitted unique identification number using the encryption processor 18 if the unique identification number is not already present in the authorisation table 28, the encryption processor 18 applying the encryption function to the unique identification number of the electronic chip 8 in association with a private key to produce the encrypted identity;
transmitting 42 the encrypted identity and a descrambling key from the authorisation apparatus 6 to the device 4 and storing 44 the encrypted identity in the device memory 10;
calculating 46 a decrypted identity from the encrypted identity using the decryption processor 12, the decryption processor 12 applying the decryption function to the encrypted identity in association with a public key to produce the decrypted identity;
comparing 48 the decrypted identity to the unique identification number of the electronic chip 8;
descrambling 50 the scrambled program instructions of the protected software using the transmitted descrambling key if a positive comparison results from the comparison of the decrypted identity to the unique identification number;
activating 52 the protected software in the storage unit 14 for employment by the device (4) as a result of a positive comparison of the decrypted identity to the unique identification number; and
retransmitting 54 the identification number of the electronic chip (8) from the device (4) to the authorisation apparatus (6) and repeating the above steps of the method 30 as a result of a negative comparison of the decrypted identity to the unique identification number.

In the current embodiment of the invention, the method 30 is carried out at the first activation or power-up of the device 4.

To activate the protected software in the storage unit 14, the electronic chip 8 is adapted to read its 56-bit identification number from a register of the electronic chip 8, the address of the register being known to the of the electronic chip 8. The 56-bit identification number of the register is compared to the decrypted identity that is converted to binary from its decimal format using binary coded decimal encoding. If the binary numbers are identical, the electronic chip 8 is directed to an activation memory address where it reads and executes the control instructions located at the activation memory address of the storage unit 14. The control instructions initiate and start the execution the program instructions of the protected software the electronic chip 8 and activate the protected software in the device 4. Following to the execution of the control instructions, the electronic chip 8 descrambles the scrambled program instructions of the protected software using the descrambling key and executes these descrambled program instructions. The protected software of the current embodiment then takes control of the operation of the device 4.

As a result of a negative comparison, the electronic chip 8 executes the instructions of the authorisation program 25 in the device memory 10 and the steps of the method 30 are repeated. The electronic chip 8 is supplied with the memory address of the authorisation program that contains the instructions of the authorisation program 25. The electronic chip 8 subsequently executes the instructions of the authorisation program 25 as a result of a negative comparison. The execution of the instructions of the authorisation program (25) initiates the retransmission of its identification number to the authorisation apparatus (6) and the steps of the method 30 are repeated after a tempo of at least 10 seconds in order to protect the system against random attacks.

The system 2 and the method 30 according to the invention remotely keep track of the activation of protected software for use in the devices 4. Each device transmits its unique identification number to the authorisation apparatus 6 and the unique identification number is recorded in the authorisation table 28. The authorisation apparatus 6 compares the received unique identification number to the unique identification numbers recorded in the authorisation table 28 and transmits a randomly generated encryption identity to the device 4 if the unique identification number is already present in the authorisation table 28. Unauthorised copying is automatically and immediately sanctioned as the device 4 will not release the protected software for use by the device 4 when a randomly generated encryption identity is received by the device 4 and thus all unauthorised copying is immediately prevented. Following a negative comparison of the decrypted identity to the unique identification number a randomly generated encryption identity is continually transmitted to the device 4 with each repetition of the method 30 and thus the protected software is never activated in the device 4.

If the unique identification number is not already present in the authorisation table 28, the unique identification number is encrypted by the authorisation apparatus 6 and only the authorisation apparatus 6 has knowledge of the private key used to encrypt the unique identification number and the descrambling key making it difficult for an external party to guess or calculate the encryption identity and to gain unauthorised access to the protected software. The resulting encrypted identity is sent to the device 4. The protected software is descrambled and activated for use by the device 4 following a successful decryption and comparison with the unique device identification number.

The authorisation apparatus 6 is completely controlled by the intellectual property rights holder of the protected software. The resulting authorisation table 28 contains up-to-date data that allows the intellectual property rights holder of the protected software to establish the number of devices in which the protected software has been activated by counting the number of different unique identification number present in the authorisation table 28.

In an alternative embodiment of the method 30, the step comparing the unique identification number received by the authorisation apparatus 6 to the unique identification numbers previously recorded in the authorisation table 28 and the step transmitting a randomly generated encryption identity to the device 4 if the unique identification number is already present in the authorisation table 28 are both omitted. In this embodiment, the repeated presence of the same unique identification number in the authorisation table 28 would indicate that unauthorised copying may be taking place and the intellectual property rights holder can then choose to take action if he wishes.

In another embodiment, the method 30 is additionally carried out at random times after the first power-up/activation of the device and only if a positive comparison of the decrypted identity and the unique identification number occurred following the first power-up/activation of the device; the method 30 transmits a randomly generating encryption identity to the device 4 if the number of times the unique identification number has been recorded in the authorisation table 28 during a predetermined time period exceeds a predefined threshold limit. In this alternative embodiment, the expected number of times the authorisation program 25 is to be executed in a certain time period can be pre-programmed, for example it is programmed to run 4 times per week but at random times. Thus the expected number of times a unique identification number should appear in the authorisation table 28 is known. If the unique identification number appears in the authorisation table 28 more often that this expected value, this would indicate that unauthorised copying maybe taking place and release of the protected software is immediately blocked. The execution of the authorisation program 25 at random times is advantageous in circumventing attacks by hackers.

In yet another embodiment, the method 30 comprises the additional steps of transmitting a software identity with the unique identification number to the authorisation apparatus 6, comparing the software identity and the unique identification with data in a licensing table, forming an encryption identity from the unique identification number and the software identity combination for which a match is found in the licensing table, transmitting a randomly generated encryption identity to the device 4 if the received unique identification number and software identity is not present in the licensing table and if the received unique identification number and software identity is present in the licensing table, activating the software version or type contained in the device 4 that matches the decryption identity when the software version or type identity combined with the unique identification number matches the decryption identity. This embodiment permits the release of a certain software version or type for use by the device 4 in accordance with the licence payment data that appears in the licensing table.

In an alternative embodiment of any one of the previously described embodiments, the protected software is unscrambled and the steps transmitting a descrambling key and descrambling the protected software instructions are omitted.

In an alternative embodiment of any one of the previously described embodiments, if the unique identification number does not match the decryption identity, the electronic chip 8 is adapted to activate the protected software for employment by the device 4 and to periodically modify or interrupt device operation at predetermined and periodic times. For example, the STB changes every 2 minutes the viewing channel that is displayed.

The system 2 and method 30 for remotely tracking the activation of protected software in electronic devices according to the invention allows the total number of devices sold to be determined as the authorisation table 28 of the authorisation apparatus 6 contains all the necessary data. The number sold in a particular country and the software version or type used in devices can also be determined through data recorded concerning the software identity and the geographical identity of the devices 4. As a result, the loss of royalty payments that are due to an ISV is prevented.

In alternative embodiments the unique identification number is stored in an electrically erasable programmable read-only memory EEPROM that is external to the electronic chip 8 or in the device memory 10.

In other alternative embodiments the communication interface 16 comprises a universal serial bus (USB) or wireless RS-232 to communicate with the authorisation apparatus 6.

In yet another alternative embodiment the public and private keys are obtained respectively by the device 4 and the authorisation apparatus 6 from a secure server through the communications network 26.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. System for remotely tracking the activation of a protected software in a device, the protected software remaining unusable by the device as long as the protected software has not been activated;
the system comprising a plurality of devices and an authorisation apparatus that are adapted to communicate with each other;
each device comprising a storage unit containing the protected software, a device memory and an electronic chip having an identification number uniquely identifying the electronic chip and the device from the other devices, and
the authorisation apparatus comprising an encryption processor adapted to calculate an encrypted identity using the identification number;
wherein each device is adapted to transmit its identification number to the authorisation apparatus;
the authorisation apparatus is adapted to record the received identification number and to transmit an encrypted identity calculated from the identification number to the device; and
the device contains a decryption processor adapted to decrypt the transmitted encrypted identity calculated from the identification number to produce a decrypted identity and the electronic chip is adapted to activate the protected software only if the identification number of the device corresponds to the decrypted identity.

2. System according to claim 1, wherein the device is further adapted to transmit a geographical identity related to the geographical location of the device to the authorisation apparatus.

3. System according to claim 1, wherein the electronic chip is adapted to read its identification number from a register of the electronic chip, to compare the identification number to the decrypted identity and to execute control instructions located at an activation memory address of the storage unit as a result of a positive comparison of the identification number and the decrypted identity; the execution of the control instructions initiating the execution of the program instructions of the protected software and activating the protected software in the device.

4. System according to claim 3, wherein the electronic chip is adapted to execute the instructions of an authorisation program located at an authorisation memory address of the device memory as a result of a negative comparison of the identification number and the decrypted identity; the execution of the instructions of the authorisation program initiating the electronic chip to retransmit its identification number to the authorisation apparatus.

5. System according to claim 3, wherein the protected software comprises scrambled program instructions, the authorisation apparatus is further adapted to transmit a descrambling key to the device with the encrypted identity, and the electronic chip is adapted to descramble the scrambled program instructions of the protected software using the descrambling key following the execution of the control instructions activating the protected software in the device.

6. Method for remotely tracking the activation of a protected software in a device belonging to a plurality of devices;
the at least one device comprising an electronic chip containing an identification number uniquely identifying the electronic chip and the device from the other devices, a storage unit containing a protected software that is unusable by the device as long as the protected software has not been activated, a decryption processor for calculating a decrypted identity and a device communication interface for communicating with an authorisation apparatus;
the authorisation apparatus comprising an encryption processor for calculating an encrypted identity, a central processor to record device related data and an apparatus communication interface for communicating with a device;
wherein the method comprises for each device the steps of:
transmitting the identification number of the electronic chip from the device to the authorisation apparatus;
recording the identification number of the electronic chip and calculating an encrypted identity from the transmitted identification number using the encryption processors;
transmitting the calculated encrypted identity from the authorisation apparatus to the device;
calculating a decrypted identity from the transmitted encrypted identity using the decryption processor;
comparing the decrypted identity to the identification number of the electronic chip; and
activating the protected software for employment by the device as a result of a positive comparison of the decrypted identity with the unique identification number.

7. Method according to claim 6, wherein the method additionally comprises the step of:
retransmitting the identification number of the electronic chip from the device to the authorisation apparatus and repeating the above steps of the method as a result of a negative comparison of the decrypted identity with the unique identification number.

8. Method according to claim 6, wherein activating the protected software for employment by the device comprises directing the electronic chip to an activation memory address of the storage unit as a result of a positive comparison and executing control instructions located at the activation memory address of the storage unit; the execution of the control instructions initiating the execution of the program instructions of the protected software and activating the protected software in the device.

9. Method according to to claim 6, wherein the protected software comprises scrambled program instructions, the authorisation apparatus further transmits a descrambling key to the device with the encrypted identity, and the electronic chip descrambles the scrambled program instructions of the protected software using the descrambling key as a result of a positive comparison.

10. Method according to claim 6, wherein the device additionally transmits to the authorisation apparatus a geographical identity relating to the geographical location of the device.

11. Method according to claim 6, wherein the protected software is activated for employment by the at least one device as a result of a negative comparison and device operation is periodically interrupted at predetermined and periodic times.

12. Device comprising an electronic chip containing an identification number uniquely identifying the electronic chip and the device from other devices, a storage unit containing a protected software that is unusable by the device as long as the protected software has not been activated, a decryption processor for calculating a decrypted identity and a device communication interface for communicating with an authorisation apparatus;
wherein the electronic chip puts into practice a method for remotely tracking the activation of a protected software in a device according to claim 6.

13. Authorisation apparatus comprising an encryption processor for calculating an encrypted identity, a central processor adapted to record device related data and an apparatus communication interface for communicating with a device;
wherein the central processor puts into practice a method for remotely tracking the activation of a protected software in a device according to claim 6.
